(19) United States
(12) Patent Application Publication
(10) Pub. No.: US 2024/0375526 A1
(43) Pub. Date: Nov. 14, 2024

(54) INTERCONNECTION DEVICE AND FUEL CELL DEVICE FOR EFFICIENT INTERCONNECTION OF FUEL CELLS, AS WELL AS MOTOR VEHICLE

(71) Applicant: STACK HYDROGEN SOLUTIONS GMBH, Aachen (DE)

(72) Inventor: David VERGOSSEN, Gangelt (DE)

(21) Appl. No.: 18/691,662

(22) PCT Filed: Sep. 14, 2022
(86) PCT No.: PCT/EP2022/075549

§ 371 Date: Mar. 13, 2024

(30) Foreign Application Priority Data
Sep. 14, 2021 (DE) 10 2021 123 774.2

(51) Int. Cl. B60L 50/72; B60L 58/30; H01M 16/00

(52) U.S. Cl. CPC B60L 50/72; B60L 58/30; H01M 16/006

(57) ABSTRACT

The invention relates to an interconnection device for interconnecting several fuel cell modules. A base element is provided therein, which provides a matrix of contact points, which can be equipped with connecting elements for implementing different interconnections. The base element has two input connections and output connections for each fuel cell module to be connected. Further, two busbars are provided, each of which is connected to one half of the output connections and each of which provides an external contact for connecting an electrical load to be supplied by the fuel cell modules. For each provided parallel branch of fuel cell modules, a diode device is provided, which is connected between one of the input connections and one of the busbars and allows a current flow only in the direction from the respective input connection to the respective busbar.

The present invention relates to an interconnection device for electrically interconnecting several fuel cell modules. The invention further relates to a corresponding fuel cell device and a motor vehicle equipped therewith.

In many areas, such as vehicle and drive technology, there is increasing emphasis on electric drives and electrification in general. Batteries, for example, are deployed for this purpose. These are typically composed of a large number of individual battery cells in order to generate a sufficiently high voltage. However, this comes with the risk that individual battery cells may fail, which can have an impact on the functionality or voltage level of the entire battery. However, corresponding measures, such as voltage adaptations or the like, can be complex and cost-intensive and can in turn represent further sources of error. Hybrid systems are also known in which several energy sources are combined with one another. However, this can often require costly, extensive and complex adaptation of the subsystems to one another and in certain situations it can be difficult to achieve efficient and effective interaction between the subsystems. For example, energy consumption in a motor vehicle can be highly dynamic, i.e., change quickly and to a large extent. Such requirements cannot be met by fuel cells, for example, without considerable effort. Therefore, a buffer battery can be used, which, however, typically has to be coupled to the fuel cell via an extensive and complex DC-to-DC converter and can also provide different voltages depending on its state of charge and/or place varying demands on an energy source for charging, which, overall, makes corresponding systems challenging.

The object of the present invention is to enable efficient application of fuel cells, especially in a motor vehicle.

This object is achieved according to the invention by the subject matter of the independent patent claims. Possible refinements and further developments of the present invention are disclosed in the dependent claims, in the description, and in the figures.

The interconnection device according to the invention is configured to electrically interconnect several fuel cell modules. A fuel cell module in the present sense can comprise one or more fuel cells, which can be electrically connected in series, in particular within the respective fuel cell module, so that the fuel cell module can accordingly provide a higher output or nominal voltage than a single fuel cell. The interconnection device according to the invention also has a base element, several connecting elements, two busbars and at least one diode device.

The base element provides a matrix of connection or contact points, which can be equipped with connecting elements for implementing different electrical interconnections. For each fuel cell module to be connected or being connectable or to be interconnected, the base element further has two input connections for connecting the positive pole and the negative poles of the respective fuel cell module. In addition, the base element has output connections via which an electrical connection can be established or implemented, i.e., can run, to an electrical load to be supplied or to an electrical load that is connected via the interconnection device to the fuel cell modules during operation. The base element can be, for example, a mounting plate, a mounting block or a three-dimensional, i.e., not necessarily flat or planar, device. The base element can—for example in the form of the contact points or as a part thereof—have mounting points or mounting holes for fastening or connecting at least the parts or components mentioned. The contact points can in particular be or comprise electrical connection points. These electrical connection points can be or provide, for example, an electrically conductive contact element, via which several parts or components connected to the respective contact point or connection point, in particular the connecting elements, can be connected to one another in an electrically conductive manner. The contact points can be formed in a main body or base body of the base element, which itself can be made of an electrically non-conductive or electrically insulating material in order to avoid short circuits.

The connecting elements can be or comprise, for example, continuous conductor or line pieces for permanent electrically conductive connections, electrical switches and/or semiconductor elements. By equipping the base element with such connecting elements, different electrical interconnections, i.e., connection configurations or electrical paths, can be implemented—flexibly or as needed due to the matrix-like arrangement of the contact points. Thus, different fuel cell devices or different interconnections or interconnection configurations of a fuel cell device can be implemented particularly easily by using the base element. In particular, no adaptation or appropriate selection or composition of the fuel cell modules themselves is necessary, since the corresponding functionality is outsourced to or into the base element. This also makes it particularly easy to maintain or repair, for example, by allowing individual damaged connecting elements to be replaced without opening a fuel cell module or its housing.

A matrix-like arrangement of the contact points can mean, for example, that they are arranged distributed over at least one surface of the base element, in particular in a regular pattern. The contact points can be spaced apart from one another in order to avoid installation space conflicts between the connecting elements when equipping the base element. For example, two adjacent contact points can be at least several millimeters or, for example, one centimeter or the like apart from each other.

By appropriate arrangement and/or by appropriate switching of switches provided as part of the connecting elements, one or more different nₛmₚ configurations of the fuel cell modules can be implemented or set, in which n fuel cell modules are connected in series and m fuel cell modules are connected in parallel, wherein n and m are predetermined integers. Such a connection of the fuel cell modules is carried out here by corresponding connection of the input connections and/or the output connections or the components connected to these connections, in that the connecting elements are or are connected to at least some of the contact points. By means of the connecting elements or in addition thereto, simple, for example, non-switchable, possibly fixed or permanent electrical connections or paths can be implemented on the base element. For example, outputs of each provided parallel branch of input connections or fuel cell modules can be connected to the busbars. Likewise, some or all of the connecting elements can be detachable and can be arranged in other positions or configurations on the base element in order to implement a specific or different connection if necessary. A connecting element or a part of the connecting elements can connect two of the contact points to one another in an electrically conductive manner. Likewise, a connecting element or part of the connecting elements can be connected to one of the contact points with only one side or end, while the other side or end of the respective connecting element is connected or connectable to another part, for example, one of the busbars or one of the fuel cell modules, or forms an open contact or connection point, for example, one of the input connections.

The busbars are each electrically connected to disjoint halves of the output connections and each provide an external contact for connecting an electrical load to be supplied by the fuel cell modules, i.e., via the interconnection device, or form such external contacts. The busbars connect or at least collect the output connections used in each case. A load connected to it or to be supplied via it can be or comprise, for example, an on-board electrical system or an electric motor of a motor vehicle or the like. The output connections can also transition to the busbars as one piece or in one piece, i.e., they can each be defined as a corresponding transition area.

For each intended parallel branch-also referred to as a parallel strand-of input connections or fuel cell modules, one, in particular exactly one, diode device is provided. This is connected between one of the input connections and one of the busbars or arranged in a corresponding electrical path. The diode device allows—at least in normal operation-a current flow only in the direction from the input connection to the busbar, in particular to the busbar that forms a positive external contact. The diode device can therefore be unidirectionally current-carrying or electrically conductive and can thereby protect the fuel cell modules from a harmful inflow of current. Such a diode device no longer needs to be provided in the individual fuel cell modules themselves, but is here integrated into the interconnection device according to the invention. As a result, the fuel cell modules can be designed more simply, or different types of or differently constructed fuel cell modules can be used flexibly, regardless of whether they have a corresponding protection mechanism or not.

In particular, the diode device can have or simulate the function of an ideal diode. The diode device can therefore be or comprise an active electronic part which represents the behavior of an ideal diode. This makes it possible to achieve a particularly low-loss and efficient connection of the fuel cell modules and a particularly efficient operation of the interconnection device.

In the present sense, a parallel branch describes an electrical path or circuit branch that is connected or switchable in parallel to other corresponding branches or paths, that is to say to other parallel branches, with respect to the external contacts. Such a parallel branch can each comprise several pairs of input connections connected in series, i.e., several fuel cell modules connected in series in the fuel cell device. These can be parallel branches that are actually connected in a specific application, i.e., in a specific fuel cell device or a specific application of the present invention, or can be switched or adjusted by means of the present invention, in particular by means of the interconnection device according to the invention.

Overall, the interconnection device according to the invention provides an electrical interconnection, that is, corresponding electrical connections, which, when the fuel cell modules are connected to the input connections of the interconnection device, electrically connects or can connect the fuel cell modules to one another in the desired, i.e., predetermined, manner configured at the interconnection device. The present invention allows a particularly simple and flexible implementation of different interconnections without, for example, having to laboriously adapt an otherwise often used wiring harness of direct connecting lines between the fuel cell modules. In addition, by means of the present invention, fuel cell modules of different voltage levels can be combined with one another particularly easily, so that a corresponding overall system, i.e., a corresponding fuel cell device, is able to support a battery connected to it over its entire SoC range, i.e., state of charge range, to supply energy. This can be implemented for or in conjunction with almost any battery, for example, from backup batteries to full-fledged traction batteries of an electric motor vehicle. By means of the present invention, for example, a fuel cell range extender system in a motor vehicle, which also has a battery, in particular a traction battery connected in parallel to the fuel cell device with respect to a traction motor of the motor vehicle, can be 15 implemented particularly simply, effectively and efficiently. The present invention also makes it possible, for example, to electrically isolate or bypass or bridge individual fuel cell modules in the event of a failure, so that a corresponding fuel cell device remains at least partially operational then. A corresponding bypass or bypass option can here advantageously be provided centrally by the interconnection device according to the invention. As a result, in order to decouple a failed fuel cell module, only the interconnection device has to be controlled and not the fuel cell module itself. This means that the corresponding functionality can be implemented particularly easily, with little effort, compactly and reliably. A further advantage of the present invention lies in the outsourcing or central provision of the diode devices in the interconnection device according to the invention. This means that the individual fuel cell modules do not have to comprise such a diode device, so that—especially when several fuel cell modules are connected in series-the total number of diode devices can be reduced compared to conventional fuel cell systems, since only one diode device has to be used per provided parallel branch.

In a possible embodiment of the present invention, the connecting elements are arranged to implement a parallel connection with at least two parallel branches of the input connections. By means of the connecting elements at least two input connections provided for different fuel cell modules are connected in parallel. Thus, by connecting fuel cell modules to these input connections, at least a 2p interconnection or configuration of the corresponding fuel cell 35 modules can be implemented. Furthermore, the connecting elements here include at least one bidirectional cross-connection switch. This at least one bidirectional cross-connection switch is arranged between the two parallel branches. The cross-connection switch can therefore establish or disconnect an electrical connection of the two parallel branches, in particular between two input connection pairs or fuel cell modules connected in series and/or directly in front of the respective diode device, which can then form the connection to the output side busbar. The cross-connection switch can therefore form a corresponding cross-connection between the parallel branches or can be arranged in such a cross-connection. The cross-connection switch can also be referred to as SQ switch for short. In particular, at least one such bidirectional cross-connection switch can be provided for each parallel branch. Exactly one or at least one cross-connection switch can then be arranged between two adjacent parallel branches or, for example, in the case of two parallel branches, two cross-connection switches can be arranged between them accordingly. The number of cross-connection switches per parallel branch can preferably correspond to the number of fuel cell modules or pairs of input connections connected in series in the parallel branch or can be less than these by one. This means that a cross-connection switch can then be connected or arranged between two fuel cell modules or pairs of input connections that are adjacent in a serial interconnection device. This can apply in particular to all pairs of fuel cell modules or pairs of input connections that are adjacent in the serial interconnection direction. Thus, a particularly high level of flexibility and variety of adjustable interconnections can be implemented. In particular, the cross-connection switches enable additional interconnections or combinations that would not be possible, for example, simply by galvanically isolating or decoupling or bypassing individual pairs of input connections or individual fuel cell modules. This means that, for example, a voltage level applied to the output connections can be set particularly flexibly or adapted to a particularly large number of different situations or requirements, for example, different states of charge of a battery connected in parallel.

In a further possible embodiment of the present invention, the connecting elements comprise at least one bypass switch, in particular at least one or exactly one bypass switch for each pair of input connections. This at least one bypass switch is connected in parallel to the respective pair of input connections, optionally in parallel to the fuel cell module connected to it, between this and one of the output connections, i.e., arranged accordingly, in order to establish or disconnect a bypass of the respective pair of input connections depending on the switching state of the bypass switch. The bypass switches can be closed in order to provide a conductive connection, for example, in place of a failed fuel cell module or a fuel cell module that has been decoupled or bypassed to adjust an output voltage, i.e., the voltage level at the output connections. This means that a corresponding fuel cell device can continue to be operated at least to a limited extent even if one or more fuel cell modules fail. In addition, the bypass switches can increase the flexibility and variety of the interconnections that can be implemented, for example, to provide different output voltages or power. Here, the bypass switches are each connected or arranged in parallel to a pair of input connections or to a fuel cell module and are therefore also referred to as SP switches.

In a specific fuel cell device that is equipped with the interconnection device proposed here, the fuel cell modules can additionally have at least one decoupling switch, in particular one at the input side and one at the output side, in order to decouple, i.e., galvanically isolate, the respective fuel cell module from the electrical interconnection, i.e., the circuitry network of the fuel cell modules. A current provided by the remaining fuel cell modules can then flow through the associated closed bypass switch, bypassing or bridging the fuel cell module decoupled in this way. The decoupling switches can preferably be designed as contactors. The decoupling switches internal to the fuel cell module can be used to achieve a particularly reliable defined electrical behavior of the respective bypass, which could otherwise be influenced in an unpredictable manner, for example, by an unknown effective resistance of a failed or damaged fuel cell module.

In a further possible embodiment of the present invention, the connecting elements comprise at least one controllable switch. This can be, for example, the at least one cross-connection switch and/or bypass switch mentioned. Here, the interconnection device further has a control device, which is configured to detect, during operation of the interconnection device or the fuel cell device equipped or operated with it, a current state of charge of a battery connected in parallel to the interconnection device or the fuel cell device comprising it with respect to an external electrical load. The control device is further configured to control, i.e., switch, the at least one controllable switch depending on the detected state of charge in order to provide a voltage adapted to the detected state of charge to the external contacts of the interconnection device. Thus, for example, correspondingly different numbers of fuel cell modules—and, thus, ultimately fuel cells—can be integrated by the control device. Typically, a fuel cell stack interconnected directly to a battery with a number of fuel cells adapted to the battery can only output electrical power to the battery when the battery is in a specific window of the state of charge. If the state of charge of the battery is outside this window of the state of charge, the fuel cell stack can no longer output electrical energy to the battery.

This problem can be circumvented here in that the number of fuel cells contributing to the output voltage can be varied by appropriately controlling the at least one controllable switch. Thus, various interconnections can be implemented in order to be able to provide, i.e., output, energy to the battery through the fuel cell modules via the interconnection device over a broader, in particular the entire, range of the state of charge of the respective battery.

In a further possible embodiment of the present invention, the interconnection device has a pre-charging circuit for adjusting a voltage provided at the external contacts and a voltage of a battery electrically connected to the external contacts during operation of the interconnection device without a voltage converter (DC-to-DC converter) connected therebetween to each other. This pre-charging circuit can in particular be designed as a switching unit with at least one semiconductor transistor switch. The pre-charging circuit can, for example, be designed as an integrated semiconductor component or can comprise one, or can be or comprise, for example, a circuit board with several parts arranged thereon, such as at least one integrated semiconductor component or integrated circuit and/or at least one SMD (surface-mounted device) and/or the like. The pre-charging circuit can, for example, comprise a housing in which the remaining components of the pre-charging circuit can be arranged, for example, cast-in. The fact that the pre-charging circuit is arranged on the output side can mean, in particular, that the pre-charging circuit is arranged in the current flow direction on a side of the input connections or the fuel cell modules that faces the busbars or one of the output contacts and that there is no input connection or fuel cell module located between the pre-charging circuit and the respective external contact in the current flow direction. The lack of a voltage converter results in an advantage over conventional solutions in terms of complexity, weight and costs, while, at the moment the interconnection device or fuel cell device and the respective battery are electrically interconnected, the pre-charging circuit achieves a dampened adjustment of their voltages or voltage levels. Thus, a pre-control of components of the fuel cell device can be implemented and, for example, abrupt electrical load changes can be dampened. The pre-charging circuit can be configured to close the semiconductor transistor switch in a controlled manner in a secondary branch and, after the voltages have been adjusted, to close a main switch arranged in a main branch and then open the semiconductor transistor switch. This would then result in a direct electrical connection between the interconnection device or the fuel cell device and the battery via the main branch with damped voltage adjustment, which can be particularly low-resistance. This makes it possible to connect the fuel cell device and the battery with particularly low load, even without a voltage converter. The pre-charging circuit can in particular correspond to the diode device mentioned or can be combined with it, in particular by functional and structural integration, in the switching unit, in the semiconductor component, on the circuit board and/or in the housing of the pre-charging circuit. If several parallel branches of pairs of input connections or of fuel cell modules are provided or can be switched, such a pre-charging circuit, for example, in the form of the respective diode device or by comprising one, can be provided for each parallel branch. Likewise, a single or common pre-charging circuit can be provided, which can then be arranged in a current or line path that brings together all parallel branches at an input side of the pre-charging circuit facing away from the respective external contact. The adjustment of the voltages can be implemented, for example, by a resistance of the pre-charging circuit or by controlled or regulated switching of the semiconductor transistor switch, for example, with gradually or stepwise increasing transmittance or increasing duty cycle or the like.

In a possible further development of the present invention, the pre-charging circuit has a dedicated inductance. Here, an electrical or electronic component is provided that serves as an inductance in the pre-charging circuit, so that not only unavoidable parasitic inductances of the other parts or components are used. By means of such an inductance, in particular connected in series upstream of the semiconductor transistor switch, an inductive portion of an overall impedance can be increased. The inductance can therefore, for example, function as a frequency-dependent resistor in combination with a basic frequency of a PWM regulation or a PWM signal for controlling the semiconductor transistor switch for adjusting the voltages that can be set by controlling or regulating the pre-charging circuit, in particular the semiconductor transistor switch. This means that steep-edged changes in a current flowing from the fuel cell modules or the input connections of the interconnection device through the pre-charging circuit can be dampened more strongly as a result of the pulse-shaped PWM control than is the case due to the inevitable parasitic capacitances that are present in the respective circuitry network. This means that current and/or voltage jumps, in particular abrupt or steep-edged ones, can be avoided or reduced by means of then interconnection device, when the fuel cell modules and the battery are interconnected. In a simple embodiment, for example, the main switch mentioned can be arranged in series in the main branch and, in parallel thereto, a resistor, the inductor and a switch, for example, the semiconductor transistor switch mentioned can be arranged in series in the secondary branch.

In a further possible development of the present invention, the pre-charging circuit comprises at least one switch or a switching device, for example, instead of the mentioned resistor in the secondary branch. Further, the pre-charging circuit here comprises a control device or a regulation for controlling the at least one switch, in particular, for regulating or automatically controlling of the switch. The control device is configured to control or switch the switch gradually or stepwise, i.e., little by little or via at least one or more intermediate steps or intermediate stages, from permanently open to permanently and completely closed. This can be done in particular depending on a current flowing from the input connections or the fuel cell modules to the pre-charging circuit while the voltages are adjusted. For this purpose, the pre-charging circuit or the interconnection device can also have a corresponding current measuring device. The current flowing to the pre-charging circuit can therefore be used here as a control or regulation variable. This means that the voltages can be adjusted according to the situation and needs, for example, as slowly as necessary and as quickly as possible. This enables safe and at the same time particularly fast and efficient operation when connecting the fuel cell device and battery. The control device can, for example, apply or implement a linear or PWM-based control or regulation. This means that the voltages can be adjusted particularly easily and with little effort and the associated reduction in component loads when connecting fuel cell modules and batteries can be achieved by the interconnection device.

In a possible further development of the present invention, the pre-charging circuit has a, in particular bistable, switchable bypass of the switch. In the closed, i.e., switched on, state, this bypass has a lower electrical resistance than the switch in its closed state. The pre-charging circuit is then configured to bypass the switch by closing the bypass after the switch or its control or regulation has reached the permanently and completely closed state. For example, the switch can be implemented as a semiconductor transistor switch, while the bypass can be designed as an electromechanical switch or can comprise an electromechanical switch. The semiconductor transistor switch then enables a particularly simple and precise control or regulation for adjusting the voltages, while the electromechanical switch can provide or form a particularly low-resistance and therefore a particularly low-loss electrical connection after the voltages have been adjusted. The bistable design of the bypass can also save energy that would otherwise have to be used to keep the bypass or the electromechanical switch in the closed state.

In particular, the bypass can be configured to be fail-safe and operationally safe, that is to say it can be configured to open automatically, that is to say to cancel the bypass if an operating or supply voltage fails. This can be implemented, for example, by a corresponding electronic circuit that is connected to the bypass or integrated into it. For example, a capacitor can be provided therein, which is automatically activated, i.e., discharged, when the operating or supply voltage of the bypass or the pre-charging circuit fails and thereby provides energy to open the bypass. This can ensure that the bypass or pre-charging circuit automatically switches to a safe state in the event of a corresponding error.

In a possible further development of the present invention, the pre-charging circuit also functionally forms an ideal diode, at least in addition to any other intended functions. In other words, the pre-charging circuit replicates the function or electrical behavior of an ideal diode. For this purpose, the pre-charging circuit can have a transistor and an associated control unit, which is configured to implement the ideal diode function by appropriately controlling the transistor. For combination with the control or regulation described elsewhere herein for equalizing the voltages of the fuel cell modules and the battery, the pre-charging circuit can, for example, comprise two transistors connected in series opposite to one another. A first of these transistors can be the switch mentioned, which can be controlled or regulated by the control device to adjust the voltages, while the other of the two transistors can serve or be configured to implement or realize the ideal diode function. An ideal diode implemented in this way can, for example, have reduced power loss compared to a real elementary germanium or silicon diode and can, thus, further reduce the energy requirement of the interconnection device, i.e., further improve its efficiency.

In a possible further development of the present invention, the cross-connection switch mentioned is designed as a switching unit which is constructed in the same way as the switching unit used as or for the pre-charging circuit. In other words, the same switching unit or assembly can be used here for the pre-charging circuit and for the or each cross-connection switch. Thus, a common parts strategy can be implemented, which enables particularly cost-effective and efficient production of the interconnection device according to the invention. The same module can also be used for the bypass switches mentioned. However, since current only flows through them or they only must carry current in one direction due to their arrangement, regardless of the predetermined or set circuitry, the bypass switches can also be constructed more simply, for example, unidirectionally current-carrying with only one of the semiconductor transistor switches or transistors mentioned. Due to the simpler structure of the bypass switches, costs and/or energy can also be saved during the operation of the interconnection device.

The switching unit proposed here, in particular an integrated semiconductor component comprised therein, can also have further integrated functionalities. For example, the switching unit can have or implement a gate control for implementing the ideal diode by means of transistors, the possibility of PWM or linear regulation of a transistor gate to represent a switch functionality, a control of a bipolar relay, such as bistable bypass, a current measurement, for example by means of a shunt and/or a Hall sensor, an over-current protection shutdown, an over-voltage protection shutdown, a configurability or configuration option via a bus connection or through appropriate IC external circuitry or via software in the flash process, a communication interface for communication with a higher-level control unit, for example via a bus connection, one or more interfaces for the external circuitry for configuration or programming, a galvanically isolated power supply for safe deployment in the high-voltage range and/or the like. By means of such a combination or integration of functionalities or features in an integrated circuit, a corresponding overall circuit and, thus, also the interconnection device according to the invention could possibly be manufactured more cost-effectively than, for example, a printed circuit board on which some or all of the functionalities mentioned are implemented by separate components or assemblies. Whether the respective switching unit behaves or should behave, for example, as a bidirectional cross-connection switch, as a diode device, as a pre-charging circuit or the like, can be determined or set, for example, by means of configuration or programming via a bus connection, via a flash process or via an external circuit, for example, via a jumper, a solder bridge, a resistor interconnection or a similar type of external circuit.

Some or all of the parts or components mentioned, such as the switches mentioned, the switching unit or switching units mentioned and/or the like, can each be mounted on the base element, in particular plugged in at its contact points, screwed or fastened in a similar or other way and, for example, be electrically connected or contacted via it. This enables particularly simple production and configuration as well as particularly simple and flexible adaptability of the interconnection device, for example, for different situations or applications.

A further aspect of the present invention is a fuel cell device, which has at least one interconnection device according to the invention and several fuel cell modules connected to the input connections thereof. The fuel cell device according to the invention can in particular be the fuel cell device mentioned in connection with the interconnection device according to the invention. Accordingly, the fuel cell device according to the invention can have some or all of the parts, components, properties and/or features mentioned in connection with the interconnection device according to the invention. For example, the fuel cell device according to the invention can comprise the control device mentioned for switching or setting different interconnections or configurations. Likewise, here the fuel cell modules of the fuel cell device according to the invention can in particular each comprise several fuel cells connected in series and/or the aforementioned input side and/or output side decoupling switches.

Accordingly, in a possible embodiment of the present invention, the fuel cell modules each have at least one, in particular at least two decoupling switches internally, which are preferably designed as a bistable contactor. The decoupling switches serve or are configured to galvanically isolate the respective fuel cell module from the rest of the fuel cell device. By opening the decoupling switch, the respective fuel cell module can be decoupled from an electrical circuitry network of the fuel cell device. The decoupling switches can also be useful if there is a bypass or bridging for the respective fuel cell module, for example, in the form of the bypass switches mentioned elsewhere, since then by opening the at least one internal decoupling switch of the respective fuel cell module a defined electrical behavior of the corresponding branch, especially of the respective bypass, can be ensured.

In a further possible embodiment of the present invention, at least some of the fuel cell modules comprise different numbers of fuel cells. In other words, the fuel cell device therefore comprises at least two, preferably several, fuel cell modules that have different numbers of internal individual fuel cells. This means that the correspondingly different fuel cell modules can provide different voltages or voltage levels. This, in combination with the possibility of setting different interconnections of the fuel cell modules using the interconnection device according to the invention, opens up an even greater flexibility or range of interconnections and a broader range of settings or uses of the fuel cell device. For example, it can be ensured in this way that a battery coupled to the fuel cell device can be supplied with energy, i.e., charged, by the fuel cell device over its entire range of the state of charge by adapting or setting the output voltage of the fuel cell device through appropriate selection and interconnection of the different fuel cell modules.

In a possible further development of the present invention, the fuel cell modules are interconnected or can be interconnected by means of the interconnection device in several parallel branches, each of which comprises several fuel cell modules interconnected in series with different numbers of fuel cells. The fuel cell modules are arranged in different parallel branches in the direction of the series interconnection in different orders with regard to their numbers of fuel cells or are connected when the corresponding series connections are implemented. The various parallel branches can comprise the same number of fuel cells overall. For example, two parallel branches can each comprise a fuel cell module with a fuel cell number A, a fuel cell module with a fuel cell number B and a fuel cell module with a fuel cell number C, where A, B and C are different integers. In one parallel branch, these fuel cell modules can then be arranged or interconnected in series in the sequence A, B, C and in the other parallel branch, for example, in the sequence C, A, B. As a result, a particularly large number of different interconnections or output voltages of the fuel cell device can be implemented particularly easily and effectively, for example, by using the cross-connection switches mentioned or the bypass switches mentioned. The cross-connection switch or switches can in particular be arranged here in such a way that those fuel cell modules from all parallel branches that have the largest number of fuel cells within their respective parallel branch can all be connected in series between an input and an output, i.e., the two output contacts of the fuel cell device. The same can apply to the fuel cell modules with the smallest number of fuel cells. In this way, a particularly wide range of output voltages of the fuel cell device that can be set using respective interconnections can be implemented. It is also possible for different parallel branches to each have a different number of fuel cells overall, for example, through different numbers and/or different designs of the fuel cell modules.

A further aspect of the present invention is a motor vehicle which has a fuel cell device according to the invention and a battery for electrically supplying an electrical load of the motor vehicle. This makes it possible, for example, to implement a fuel cell based range extender drive system. The battery can also be, for example, a relatively smaller buffer battery or the like. The fuel cell device and the battery are connected in parallel to one another with respect to the electrical load without a DC-to-DC converter connected therebetween. The load can be, for example, an on-board electrical system, electrical components or devices connected to it, an electric drive motor and/or the like. The battery can in particular be a high-voltage or traction battery of the motor vehicle. The motor vehicle according to the invention can in particular be the motor vehicle mentioned in connection with the other aspects of the present invention and can accordingly have some or all of the properties and/or features mentioned there. Such an electric motor vehicle represents a particularly useful application of the present invention, since on the one hand, as described above, electrical loads or performance requirements can vary particularly strongly and quickly during driving operation and, on the other hand, a reduction in weight, components and complexity can have a direct positive effect on efficiency, range and sustainability of the motor vehicle.

Further features of the invention can result from the following description of the figures and from the drawing. The features and combinations of features mentioned above in the description as well as the features and combinations of features shown below in the description of the figures and/or in the figures alone can be used not only in the combination specified in each case, but also in other combinations or on their own, without departing from the scope of the invention.

The drawing shows in:

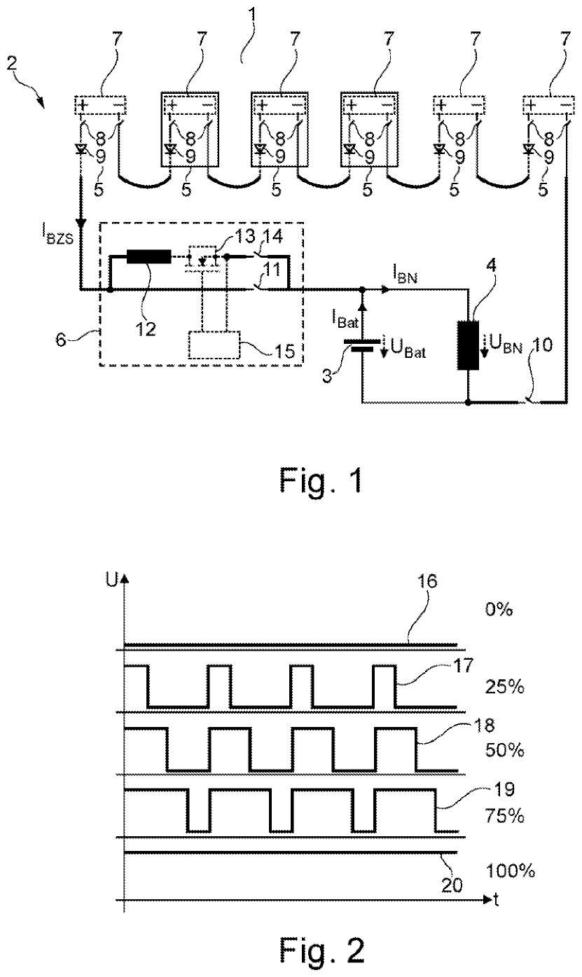

FIG. 1 a schematic representation of a motor vehicle with a fuel cell device and a battery connected in parallel thereto;

FIG. 2 a schematic diagram representation to illustrate a control of a pre-charging circuit of the fuel cell device;

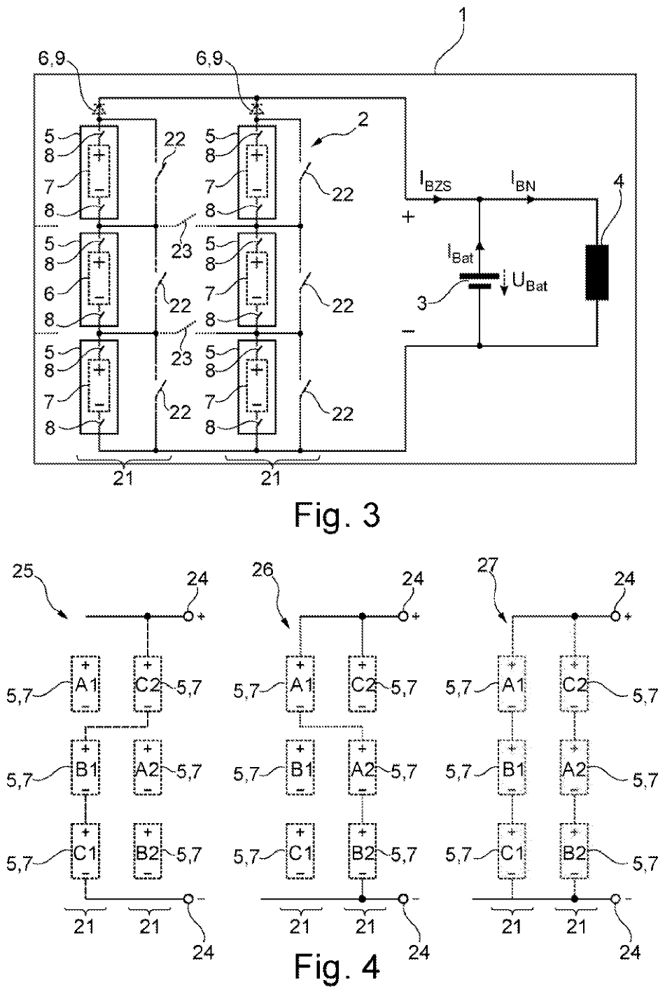

FIG. 3 a schematic representation of the motor vehicle in another configuration;

FIG. 4 a partial schematic representation of the fuel cell device in three different interconnections;

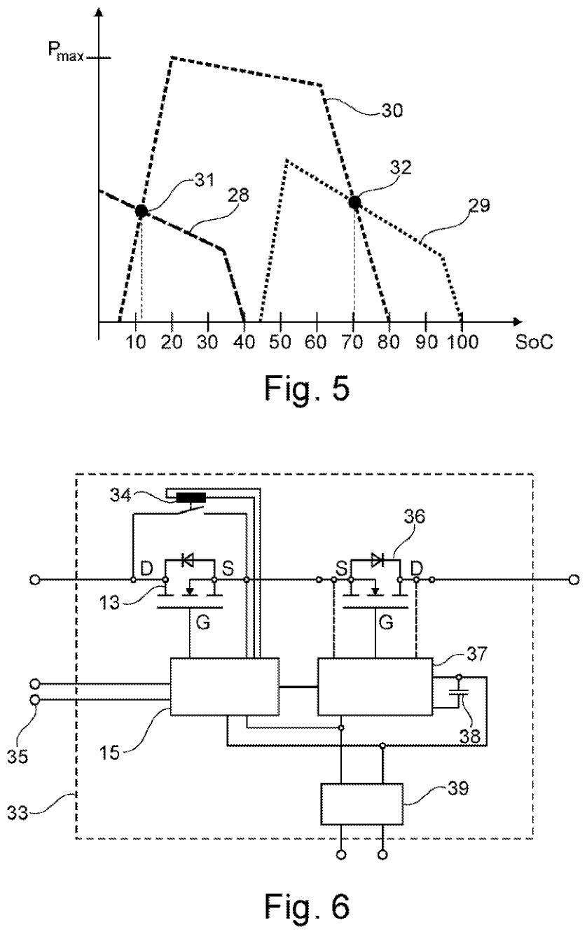

FIG. 5 a schematic diagram representation to illustrate a power feed from the fuel cell device into the battery;

FIG. 6 a partial schematic representation of a switching unit of the fuel cell device in a first variant;

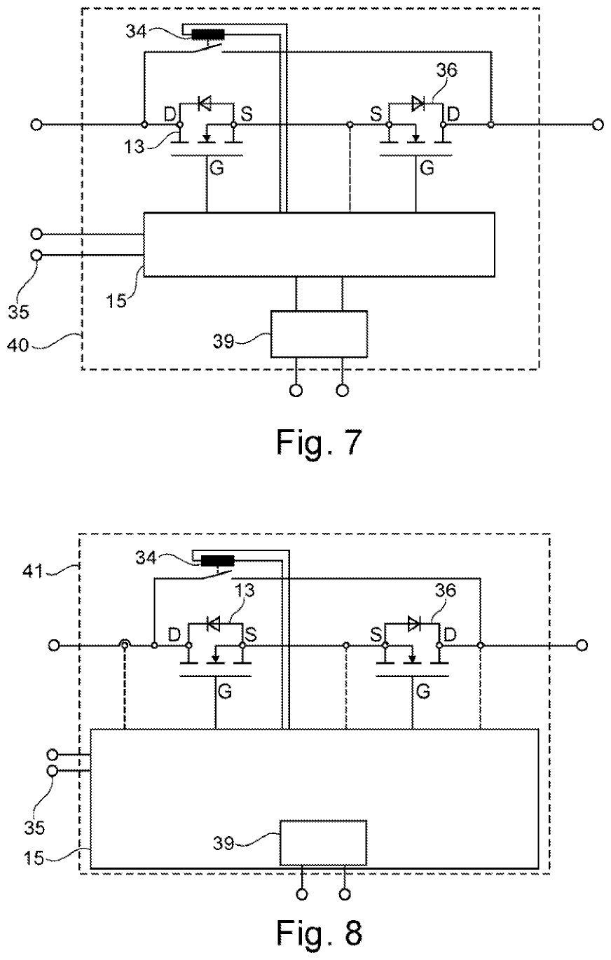

FIG. 7 a partial schematic representation of a switching unit of the fuel cell device in a second variant;

FIG. 8 a partial schematic representation of a switching unit of the fuel cell device in a third variant; and

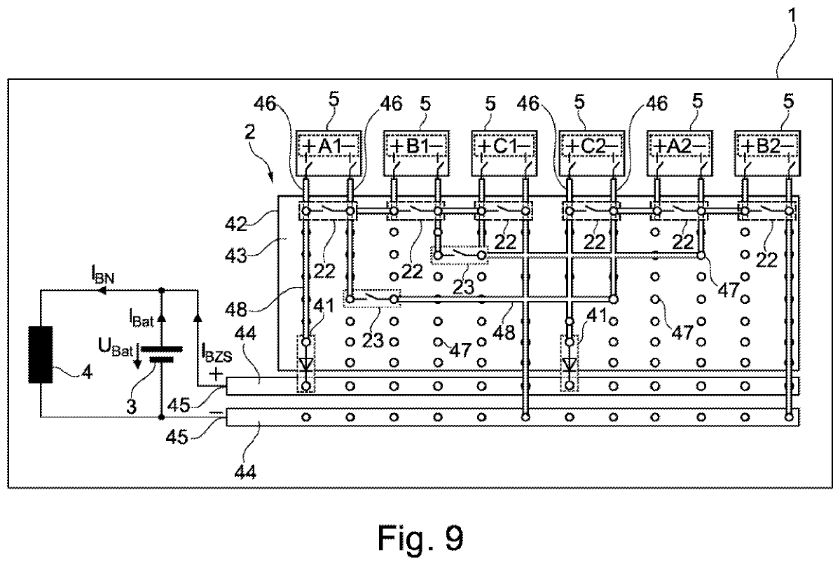

FIG. 9 a further partial schematic representation of the motor vehicle to illustrate an interconnection device of the fuel cell device.

Identical or functionally identical elements are provided with the same reference signs in the figures. For the sake of clarity, only a representative selection of elements that occur multiple times is explicitly marked.

Fuel cell systems, for example for vehicles, can comprise stacks of several fuel cells and, thus, a corresponding number of bipolar plates. A total voltage U_{BZS} generated or output by such a fuel cell system is then composed of the sum of the cell voltages U_{Z} of the individual fuel cells. In order for a fuel cell system to deliver its energy to a load or an energy storage device, certain requirements must be met. Especially in a vehicle, electrical energy consumption can be very dynamic, which means that either the fuel cell system has to meet the corresponding highly dynamic performance requirements through a correspondingly highly dynamic tracking of the media hydrogen and oxygen or that at least a part, in particular a large part, of a corresponding dynamic must be absorbed by a buffer storage, for example, a high-voltage or traction battery of the vehicle. In the case of a corresponding combined system of fuel cells and a traction battery in a vehicle, one can then speak of a fuel cell range extender, in particular if a total contribution of a battery capacity of the traction battery to the range of the vehicle is at least in the range of the range gained by the fuel cell system. However, with such a combined system there is the challenge of coupling the fuel cell system, the traction battery and the vehicle's electrical loads.

In order to omit a complex and expensive DC-to-DC converter, which converts the voltage U_{BZS} of the fuel cell system, in principle, a direct connection of the fuel cell system and the traction battery can be considered. However, this can result in restrictions regarding the operating window of the fuel cell system. If the fuel cell system and traction battery are electrically connected in parallel, an operating point will be established on the polarization curve of the fuel cell system, which will be defined by the resulting voltage. This is called voltage controlled operation. Corresponding to such an operating point, a maximum electrical power that can be delivered to the traction battery by the fuel cell system is established. This power can vary depending on the state of charge of the traction battery, whereby electrical power can possibly only be delivered from the fuel cell system to the traction battery in a limited range or window of the state of charge, for example, between 45% and 100% of the state of charge.

Against this background, FIG. 1 shows a partial schematic representation of a motor vehicle 1, which is equipped with a fuel cell device 2 and a battery 3, which together provide electrical energy to supply an on-board electrical system 4 of the motor vehicle 1. The fuel cell device 2 can provide a fuel cell current I_{BZS} and the battery 3 can provide a battery current I_{Bat} with its battery voltage U_{Bat}, which results in an on-board electrical system current I_{BN}. Here, U_{BN} refers to an on-board electrical system voltage in the on-board electrical system 4.

The fuel cell device 2 comprises several fuel cell modules 5 as well as a pre-charging circuit 6. The fuel cell modules 5 can each comprise a fuel cell stack 7 made up of several individual fuel cells connected in series as well as input side and output side decoupling switches 8. The decoupling switches 8 can be implemented as contactors, for example. Further, diode devices 9 are provided here, which can ensure that the fuel cell current I_{BZS} flows exclusively in the direction from the fuel cell device 2 into the battery 3 or to the on-board electrical system 4 in order to avoid damage to the fuel cell stack 7. In a simple case, the diode devices 9 can be implemented, for example, by Schottky diodes, which have a lower forward voltage compared to germanium or silicon diodes and, thus, have or can require lower power loss and comparatively lower cooling effort associated therewith.

On the input side of the fuel cell device 2, an input contactor 10 is provided here, through which the input side of the fuel cell device 2 can be separated from the on-board electrical system 4 and the battery 3.

On the other side of the on-board electrical system 4 and the battery 3, the pre-charging circuit 6 has a main contactor 11 in a main branch for disconnecting or decoupling the output side of the fuel cell device 2 from the on-board electrical system 4 or the battery 3. By closing the input contactor 10 and the main contactor 11, the fuel cell device 2 and the battery 3 can be connected together. However, the fuel cell device 2 and the battery 3 can have different voltage situations or voltage levels, so that a damped adjustment can be beneficial when interconnecting. Such a damped adjustment is made possible here by the pre-charging circuit 6, which can therefore also be referred to as an adjustment circuit.

For this purpose, in a simple case, the pre-charging circuit 6 can have a resistor which can be predetermined or dimensioned according to a respective requirement, i.e., for setting a desired time constant τ=R·C for the voltage adjustment between the fuel cell device 2 and the battery 3. Here, C denotes the parasitic capacities contained in both subsystems, i.e., the battery device 2 and the battery 3.

To interconnect the fuel cell device 2 and the battery 3, the input contactor 10 and a switch connected upstream or downstream of the resistor can then be closed with the main contactor 11 open. After a predetermined, for example experimentally determined, time has elapsed, for example, after t˜5_{τ}, the voltage adjustment has at least essentially taken place, so that the main contactor 11 can then be closed and the switch connected upstream or downstream of the resistor can be opened. This can be carried out automatically by appropriately controlling the pre-charging circuit 6.

Some or all of the switches or contactors used can in particular be bistable, but can be configured to open automatically in the event of an operating voltage failure. This means that reduced energy consumption, i.e., increased efficiency, can be achieved without restricting safety, since the coils of the contactors or corresponding relays do not have to be permanently energized in order to maintain a certain switching state.

Instead of a simple resistor, a semiconductor circuit can also be used. In the present case, the pre-charging circuit 6 has a serial connection consisting of an inductance 12, a first transistor 13 and a secondary contactor 14 in a secondary branch parallel to the main branch or the main contactor 11. The first transistor 13 can be switched or regulated automatically here by a control device 15, for example, within the framework of or in the form of a linear regulation or a PWM regulation, in which the gate-source path of the first transistor 13 is charged with a PWM signal generated by the control device 15. With a PWM regulation of the first transistor 13, it is not regulated linearly, but rather operated in a pulsed manner. As a result, a power loss parabola of the first transistor 13 passes through more quickly, which enables less heating and, thus, a higher overall efficiency.

The first transistor 13 can be designed, for example, as a self-locking N-FET. The fuel cell current I_{BZS} can be measured as a controlled variable by an ammeter not represented in detail here and can be used by the control device 15.

By automatically adjusting the control or regulation of the first transistor 13, the time constant τ mentioned for the voltage adjustment can be varied. This allows, for example, for variable system parameters, which can have an influence on the time-constant τ, to be taken into account or compensated for. Such system parameters or the time constant τ can change, for example, depending on a temperature of the overall system, i.e., one or more of the components described.

The motor vehicle 1 or its electrical system represented schematically here, in particular the fuel cell device 2, can have further parts or components not represented in detail here, such as seals, a gas diffusion system, coated membranes, electronics, an air compressor, valve, actuator, and sensor technology and/or the like.

To interconnect the fuel cell device 2 and the battery 3, the input contactor 10 and the secondary contactor 14 can first be closed with the main contactor 11 open. The first transistor 13 is then controlled or regulated by the control device 15, for example, by means of a PWM regulation. The pulse-pause ratio, i.e., a temporal portion of an ongoing operating time at which the first transistor 13 is closed, i.e., switched on and, thus, conductive, is increased until it has reached a value of 100%, which means that the first transistor 13 then switches on permanently and completely. Optionally, a predetermined period of time to can then be waited for in order to complete the voltage adjustment. This time can, for example, be established or determined experimentally or based on models. Optionally, after this time has elapsed, the main contactor 11 can then be closed. This can then be done with particularly little voltage and without a voltage jump, since due to the previous voltage adjustment at least essentially the same voltage level is already present on both sides of the main contactor 11. When the main contactor 11 is closed, the secondary contactor 14 can be opened in order to achieve the most direct and low-resistance coupling possible of the fuel cell device 2 to the battery 3 or the on-board electrical system 4.

FIG. 2 shows a schematic diagram representation in which a PWM regulation of the first transistor 13 is illustrated. However, continuous regulation is also possible. Here, a voltage U is plotted against time t, wherein five voltage or PWM signals are represented that are present at different times and that are set or switched one after the other during the voltage adjustment. Initially, i.e., when or immediately after the secondary contactor 14 closes, the first transistor 13 is activated with a first PWM signal 16. By doing so, the first transistor 13 is permanently blocked, corresponding to a pulse-pause ratio of 0%. The first transistor 13 is then controlled with a second PWM signal 17 with a pulse-pause ratio of 25%. In a corresponding manner, the first transistor is then gradually controlled with a third PWM signal 18 with a pulse-pause ratio of 50% and then with a fourth PWM signal 19 with a pulse-pause ratio of 75% and finally with a fifth PWM signal with a pulse-to-space ratio of 100%, so that it is then fully switched on. A change from one PWM signal or pulse-pause ratio to the next can be carried out in accordance with the regulation after a predetermined period of time or after a period of time that results depending on the fuel cell current I_{BZS} that sets in. The specific pulse-pause ratios represented here are only to be understood as examples. Other pulse-pause ratios can also be used or set.

When controlling or regulating the first transistor 13 with the PWM signals 17, 18, 19 represented, relatively rapid current changes can result due to their steep edge, which can be dampened by the upstream inductance 12 in order to reduce the load on the components.

FIG. 3 shows a further schematic representation of the motor vehicle 1, in which the fuel cell modules 5 are arranged in a 3s2p connection or configuration. Here, there are also two parallel branches 21, each made up of three connected in series or switchable fuel cell modules 5. For the sake of brevity, the parts and components already explained will not be explicitly described again below. In the arrangement represented here, each parallel branch 21 has exactly one diode device 9 arranged on its output side. In addition, each fuel cell module 5 can be bypassed by closing a respective bypass switch 22. Furthermore, two cross-connection switches 23 are provided here, which can each connect the parallel branches 21 between two connected in series or switchable fuel cell modules 5. By opening and closing the bypass switch 22, the cross-connection switch 23 and the internal fuel cell module decoupling switch 8, a plurality of different interconnections can be implemented, for example, by a control device of the motor vehicle 1 or the fuel cell device 2, which is not represented in detail here.

As already mentioned, a conventional fuel cell system can typically only deliver electrical power or energy to an energy storage device, here, for example, to the battery 3, within a limited state of charge window, if the fuel cell system is connected or interconnected directly to the battery 3 with a number of fuel cells adapted to a voltage level of the battery 3. In contrast thereto, this state of charge window, in which the fuel cell device 2 can output energy to the battery 3, is expanded here, since by opening or closing a corresponding selection of the bypass switches 22 and/or the cross-connection switches 23 the number of fuel cells of the fuel cell device 2, which contribute to output voltage or transmission of power, can be adapted effectively.

FIG. 4 shows, by way of example and in sections, schematically three different possible interconnections of the fuel cell device 2 or the fuel cell modules 5, by means of which different voltages or voltage levels can be provided at or between external connections 24. This is supported here by the fact that the individual fuel cell modules 5 have different numbers of fuel cells in each parallel branch 21. Respective fuel cell modules 5 with a first fuel cell number A, a second fuel cell number B and a third fuel cell number C are arranged in a first parallel branch 21. The fuel cell modules 5 of the other parallel branch 21 here have, for example, the same fuel cell numbers A, B, C, but are arranged in a different order between the external connections 24 when viewed in the serial connection direction. The numbers 1, 2 following the fuel cell numbers A, B, C indicate whether the respective fuel cell module 5 is part of the first or second parallel branch 21. By way of example, in a first interconnection 25 the fuel cell modules 5 with the fuel cell numbers B, C of the first parallel branch 21 and the fuel cell module 5 with the third fuel cell number C of the second parallel branch 21 are connected in series by closing one cross-connection switch 23 and opening the other cross-connection switch 23 and decoupling three of the fuel cell modules 5.

In an analogous manner, two fuel cell modules 5 of the second parallel branch 21 and one fuel cell module 5 of the first parallel branch 21 are connected in series in a second interconnection 26. In a third interconnection 27, all fuel cell modules 5 are connected in series in both parallel branches 21 and the two parallel branches 21 are connected in parallel in order to provide the maximum voltage and power.

Likewise, a variety of other interconnections of the 3s2p configuration represented as well as different mₛnₚ configurations, each with m parallel branches 21 from n serially arranged fuel cell modules 5, are possible.

The different interconnections or configurations result in different power curves and different state of charge windows for the energy transfer from the fuel cell device 2 to the battery 3, in which energy transfer is even possible.

For this purpose, FIG. 5 exemplary shows an of a diagram view in which a power that can be delivered or transferred to the battery 3 by the fuel cell device 2 is plotted based on a maximum power Pₘₐₓ over the state of charge SoC of the battery 3. Here, a first power curve 28 corresponding to the first interconnection 25, a second power curve 29 corresponding to the second interconnection 26 and a third power curve 30 corresponding to the third interconnection 27 are plotted. It can be clearly seen here that no single interconnection can be used to transmit power across the entire state of charge range. In addition, different interconnections can transfer power to the battery at certain states of charge SoC, but at different levels. This can be taken into account by the control device mentioned. For example, the control device for feeding the battery 3 from the fuel cell device 2 with maximum power can set the first interconnection 25 in the case of a particularly low state of charge SoC or when the battery 3 is at least almost completely discharged until a state of charge SoC marked here by a first switching point 31, for example, about 12% has been reached. When this first switching point 31 is reached, the control device can then automatically switch the fuel cell device 2 into the third interconnection 27 until a second switching point 32—in the present example approximately corresponding to a state of charge SoC of 70%—is reached. The control device can then automatically set the second interconnection 26 in order to be able to fully charge the battery 3.

The specific course of the power curves 28, 30, 29 as well as the exact position of the switching points 31, 32 are to be understood here purely as examples and can depend on individual properties of the fuel cell device 2, the battery 3 and/or other electrical components of the motor vehicle 1.

In any case, the control device can be configured to automatically switch between different interconnections, i.e., different switching states or switch positions of the decoupling switch 8, the bypass switch 22 and/or the cross-connection switch 23, depending on the current state of charge SoC of the battery 3. For this purpose, for example, a corresponding characteristic map, a criterion, a guideline or the like can be specified, for example, stored in a data memory of the control device. As a result, for example, an interconnection can be set depending on need or situation for maximum power output from the fuel cell device 2 to the battery 3, charging the battery 3 as evenly or gently as possible, minimizing degradation, maintaining a temperature criterion or the like.

By appropriately setting different interconnections, i.e., different combinations of the fuel cell modules 5 and, thus, different numbers of fuel cells, it can thus be achieved that, despite the direct interconnection or connection of the fuel cell device 2 to the battery 3, a power output to the battery 3 can be implemented over its entire state of charge range, without a DC-to-DC converter, for example, being or having to be connected between the fuel cell device 2 and the battery 3.

Since only a selection or subset of the fuel cell modules 5 is actually integrated into, i.e., is used in, the electrical system of the motor vehicle 1, at least at times depending on the needs or situation, this can also result in an increased service life of the fuel cell device 2, compared to conventional fuel cell systems in which all fuel cell modules 5 are always deployed to generate power.

The diode devices 9, in particular in their form or functionality as an ideal diode, and the pre-charging circuit 6 can be implemented or combined in a circuit or assembly that can be at least partially manufactured using semiconductor technology or as an integrated circuit. FIG. 6 shows a partial schematic representation of a corresponding switching unit 33. Here, the control device 15 can be connected to a gate G of the first transistor 13 for the PWM control or PWM regulation and can provide or detect a gate reference potential at the source S of the first transistor 13. Moreover, a bypass relay 34, which can also be controlled or switched by the control device 15, is provided here and can bypass the first transistor 13 from its drain and source side with a connection of comparable lower resistance or loss. The bypass relay 34 can in particular be designed to be bistable in order to save energy by using a coil that, due to its principle, cannot be permanently energized. The control device 15 can automatically close the bypass relay 34 to bypass the first transistor 13 or control it to close a corresponding switch when the first transistor 13 has reached the pulse-pause ratio of 100% during or after the voltage adjustment. As a result, losses that otherwise arise due to the small but still existing contact resistance of the fully switched-on first transistor 13 can be avoided or reduced.

To control the switching unit 33 or the control device 15 as well as for any communication or data transmission with or from a higher-level host system or a higher-level control unit, for example, the aforementioned control device or electronics of the motor vehicle 1, a bus connection 35 is provided here, for example. This can in particular be galvanically isolated, for example, opto-decoupled.

The switching unit 33 further comprises a second transistor 36, which is controlled or operated by a diode regulation 37 to implement the ideal diode function. The diode regulation 37 can be based on or comprise a component or a circuit that is designed to implement an ideal diode by controlling the second transistor 36-for example, a field effect transistor. Since such an part or circuit can contain a charge pump, a capacitor 38 is also indicated here. For example, an integrated circuit of the type LM74700-Q1, which was designed for the automotive manufacturing environment, can be used for the diode regulation 37. The diode regulation 37 can measure a voltage difference occurring there at the gate G and the source S of the second transistor 36 and either switch the second transistor 36 completely on or block a current flow through the second transistor 36.

Further, the switching unit 33 can comprise a galvanically insulating DC-to-DC converter or a galvanic insulation, referred to here as galvanic isolation 39, in order to enable simple control and supply of the components described even when they are deployed or operated in the high-voltage environment of the fuel cell device 2 and the battery 3. The galvanic isolation 39 can be, for example, a galvanically isolated or galvanically isolating circuit for supplying energy to the remaining components of the switching unit 33.

As described, the switching unit 33 can combine the function of an ideal diode and the function of the adjustment or pre-charging circuit 6 described and can therefore also be referred to as AID. Such a switching unit 33 or AID can be arranged in each parallel branch 21, in particular exactly once. The switching unit 33 can function, on the one hand, as an ideal diode and, on the other hand, as a control element for controlling or regulating the respective current through the respective fuel cell module 5 or the respective series connection of the fuel cell modules 5 of the respective parallel branch 21.

The switching unit 33 is to be understood here as a component or an assembly, for example, on a single circuit board or in a single common housing, which can be constructed as compactly as possible, so that it can be plugged in, screwed therewith or similarly attached in an electrically conductive and mechanically stable manner to, for example, a mounting plate explained in more detail elsewhere, a mounting block or a three-dimensional assembly device or the like. This means that the diode devices 9 can then be removed from the fuel cell modules 5 and deployed or arranged particularly easily and flexibly for different interconnections or configurations of the fuel cell modules 5 or the fuel cell device 2.

FIG. 7 shows a partial schematic representation of an at least partially semiconductor-based switch device 40, such as can be used, for example, as or for the bypass switch 22 and/or the cross-connection switch 23. The switch device 40 is constructed here similarly to the switching unit 33. Here too, the first transistor 13 and the second transistor 36, for example, field effect transistors or other suitable semiconductor switches, can be deployed and at least the first transistor 13 can be combined with a, in particular bistable, bypass relay 34.

Here too, the first transistor 13 and the second transistor 36 are arranged in opposite directions between an input and an output of the switch device 40 and form an adjustable semiconductor switch, which can be controlled or regulated by the control device 15 by means of a linear regulation or PWM regulation. The control device 15 can therefore be used to set a current flowing through the transistors 13, 36 or the switch device 40. In particular, not only binary switching into a completely switched-on, i.e., conductive, or completely blocked switching state, but also modulation or regulation with intermediate on-state states is possible.

The use of semiconductor switches proposed here instead of conventional electromechanical switches, at least for the bypass switches 22 and/or the cross-connection switches 23, can at least almost completely avoid wear of switching contacts that occurs with electromechanical switches, whereby the service life and robustness can be improved. In addition, the semiconductor switches enable controllable or gradual, i.e., somewhat gradual switching, in contrast to sudden or abrupt switching with electromechanical switches. This can also have a positive effect on the service life of the entire system and facilitate pre-control of the connections or material connections in the fuel cell device 2 or the electrical system of the motor vehicle 1.

The potential disadvantage of the semiconductor switches, that they can have a higher electrical resistance than a conventional electromechanical switch even when switched on, i.e., closed, can be compensated for or minimized by the respective bypass relay 34. Such a bypass relay 34 can—unlike what is represented here—optionally also be provided for bypassing the second transistor 36 controlled by the control device 15. Here, a semiconductor switch or transistor can be combined with an electromechanical switch, whereby the latter can only being closed or maintained closed when the semiconductor switch or transistor has reached its fully switched on state, i.e., its maximum electrical conductivity. This means that contact resistance can be minimized at a corresponding point or route. When the corresponding electromechanical switch is closed in this way, here, for example, the bypass relay 34 or an electromechanical switch actuated by it, with the semiconductor switch or transistor switched on, the wear mentioned on the switching contacts of the electromechanical switch can also be minimized, since between the two sides of the semiconductor switch or transistor bypassed by the electromechanical switch no significant voltage drop occurs any more, i.e., there is no significant voltage difference. When opening, i.e., disconnecting or interrupting, the corresponding connection or route, the electromechanical switch can first be opened in the reverse order in order to minimize wear, i.e., contact erosion, and then the semiconductor switch or transistor can be opened or blocked completely or partially.

The control device 15 can be implemented here as an integrated circuit, through which the gate control for the first transistor 13 and the second transistor 36, the relay control of the at least one bypass relay 34 and a provision or tapping of a gate reference potential between the transistors 13, 36 as well as connections for the bus connection 35 and a, in particular potential-free, power supply via the galvanic isolation 39 can be implemented.

Since current only flows through the bypass switches 22 in the parallel branches 21 in one direction due to the respective diode device 9 or the respective AID in the parallel branches 21 during operation, regardless of the set connection of the fuel cell modules 5, a reduced or simplified form of the switch device 40 can be used for the bypass switches 22. The second transistor 36 and accordingly also its gate control can be omitted, i.e., eliminated. This can potentially save costs and energy consumption. Unlike the variant of the switch device 40 represented in FIG. 7, which is configured for bidirectional power supply, such a reduced or simplified version can only be configured for unidirectional power supply.

Likewise, the functionality of a bidirectional switch can be combined or integrated with the described functions of the AID, i.e., the function of an ideal diode and the switch regulation for voltage adjustment. FIG. 8 shows a partially and schematically a corresponding compact switching unit 41. The compact switching unit 41 is basically constructed similarly to the switching unit 33 and the switch device 40. However, other or further functions are integrated into the control device 15. Thus, here are a current and voltage measurement input provided before bypassing the first transistor 13, its linear or PWM-based gate control, the relay control for the bypass relay 34, the gate reference potential or a corresponding measurement input between the transistors 13, 36, the linear or PWM-based gate control of the second transistor 36 and a voltage measuring input arranged downstream of it, i.e., arranged on the output side of it. Therefore, the control device 15 can here have or integrate at least the following functionalities: gate control to implement an ideal diode by using transistors, the possibility of linear or PWM regulation of at least one gate for mapping a switch functionality, control of a bipolar relay, current measurement, in particular by means of a Shunt and/or Hall sensor, over-current protection shutdown, over-voltage protection shutdown, configurability via software in the flash method or through appropriate external wiring or via bus via the bus connection 35 and communication with a higher-level control unit via a corresponding communication interface and/or the bus connection 35. Likewise, further interfaces for external wiring, for programming and/or configuration can be provided, i.e., integrated into the control device 15 or the compact switching unit 41. Some or all of the functionalities mentioned can therefore be integrated in an integrated circuit configured for this purpose, which can form the control device 15 or be part of it. This can enable a particularly cost-effective implementation of the various functionalities or a corresponding overall circuit, for example, in comparison to implementation using separate components.

The compact switching unit 41 can therefore be used as or for the pre-charging circuit 6, the diode device 9, the bypass switch 22 and/or the cross-connection switch 23. Therefore, it can also be referred to as S-AID.

FIG. 9 shows a further partial schematic representation of the motor vehicle 1 with the fuel cell device 2 and the battery 3 connected in parallel to supply the on-board electrical system 4, wherein a practical implementation of the fuel cell device 2 is indicated. Here, a central interconnection device 42 is provided, via which the interconnection or the various interconnections of the fuel cell modules 5 are implemented or can be implemented and which establishes or forms the connection between the fuel cell modules 5 and the battery 3 or the on-board electrical system 4. Here, the interconnection device 42 comprises a base element 43, which can be, for example, an electrically non-conductive mounting plate or a three-dimensional mounting structure or the like. The base element 43 is connected to an output-side busbar 44 via several compact switching units 41. On the input side, however, a further busbar 44 forming the other pole can be connected to the base element 43 directly or via corresponding direct lines. A 3s2p interconnection or configuration of the fuel cell modules 5 is represented here as an example. Since one, in particular exactly one, compact switching unit 41 can be provided for each parallel branch 21 for connection to the output-side busbar 44, this busbar 44 is electrically connected here via exactly two compact switching units 41 to the base element 43 or above it to the fuel cell modules 5. In other interconnections or configurations, more or fewer compact switching units 41, i.e., AIDs or S-AIDs, can be provided.

The busbars 44 form external contacts 45 for connecting to the battery 3 and the on-board electrical system 4. On the fuel cell module 5 side, however, input connections 46 are provided for electrically connecting the fuel cell modules 5. These input connections 46 can be implemented, for example, by appropriately configured contact points 47, plugs, sockets, sliding contacts or the like.

Here, the base element 43 has a large number of corresponding contact points 47, of which only a selection is explicitly marked here for the sake of clarity. Depending on requirements, the contact points 47 can be or comprise, for example, mounting holes, plug-in brackets, electrical connection points or the like. The parts or components mentioned can be plugged on or plugged in, screwed or attached in some other way to these contact points 44, for example.

Due to the matrix-like arrangement of the contact points 47, different interconnections or configurations of fuel cell modules 5 can be implemented or adapted particularly easily and flexibly. For example, not only the output side compact switching units 41, but also the described bypass switches 22 and cross-connection switches 23 are arranged or fastened on or at the base element 43 as part of the interconnection device 42. These parts or components are electrically connected to one another here by connecting lines 48, which can be connected or fastened, for example, directly to the respective parts or components or also to the corresponding contact points 47. At intersection points of several connecting lines 48, these can be electrically insulated from one another, for example, by overmolding with a PVC or silicone material or the like.

Due to the realization or implementation described here, a particularly simple, effective, efficient and flexible combination of a fuel cell device 2 and a battery 3 in a directly connected parallel connection to supply an electrical load, here represented by the on-board electrical system 4, can be implemented. By appropriately switching or controlling the interconnection device 42, i.e., appropriately opening or closing one, several or all of the bypass switches 22 and/or the cross-connection switches 23, as well as by appropriately controlling or regulating the compact switching units 41, different output voltages of the fuel cell device 2, power adaptation for supplying the on-board electrical system 4 and/or for charging the battery 3 from the fuel cell device 2, an electrical supply to the on-board electrical system 4 and/or the battery 3 with maximum charging power, maximum Efficiency, minimal degradation and/or the like can be set or achieved, for example, by appropriately adjusting, controlling or regulating a switching or clock frequency of the compact switching units 41 or the like.

Overall, the examples described show a system and a method for the low-loss electrical combination of fuel cells and their controlled or regulated coupling to a battery device, for example, for an electric vehicle.

### LIST OF REFERENCE NUMERALS

1 motor vehicle
2 fuel cell device
3 battery
4 on-board electrical system
5 fuel cell module
6 pre-charging circuit
7 fuel cell stack
8 decoupling switch
9 diode device
10 input contactor
11 main contactor
12 inductance
13 first transistor
14 secondary contactor
15 control device
16 first PWM signal
17 second PWM signal
18 third PWM signal
19 fourth PWM signal
20 fifth PWM signal
21 parallel branch
22 bypass switch
23 cross-connection switch
24 external connections
25 first interconnection
26 second interconnection
27 third interconnection
28 first power curve
29 second power curve
30 third power curve
31 first switching point
32 second switching point
33 switching unit
34 bypass relay
35 bus connection
36 second transistor
37 diode regulation
38 capacitor
39 galvanic isolation
40 switch device
41 compact switching unit
42 interconnection device
43 base element
44 busbars
45 external contacts
46 input connections
47 contact points
48 connecting lines
A first fuel cell number
B second fuel cell number
C third fuel cell number
D drain
G gate
S source
I_{BZS} fuel cell current
I_{BN} on-board electrical system current
I_{Bat} battery current
U_{Bat} battery voltage
U_{BN} on-board electrical system voltage
Pₘₐₓ maximum power
SoC state of charge
t time

1. An interconnection device for electrically interconnecting several fuel cell modules (5), comprising
a base element, which provides a matrix of contact points, which can be equipped with connecting elements for implementing different electrical interconnections, and has two input connections for each fuel cell module for connecting the positive and negative poles of the respective fuel cell module and output connections,
several connecting elements which are connected to at least some of the contact points in order to implement at least one predetermined interconnection of the input connections,
two busbars, each of which is electrically connected to one half of the output connections and each of which provides an external contact for connecting an electrical load to be supplied by the fuel cell modules, and
for each provided parallel branch of fuel cell modules, one diode device, which is connected between one of the input connections and one of the busbars and allows a current flow only in the direction from the input connection to the busbar,
on the output side, a pre-charging circuit for adjusting a voltage provided at the external contacts and a voltage of a battery electrically connected to the external contacts during operation of the interconnection device without a voltage converter connected there between to each other, wherein
a) the pre-charging circuit comprises at least one switch and a control device for controlling the at least one switch and wherein the control device is configured to gradually control the switch from permanently open to permanently and completely closed, and/or
b) the connecting elements are arranged to implement a parallel interconnection with at least two parallel branches of the input connections and comprise at least one bidirectional cross-connection switch, wherein the at least one bidirectional cross-connection switch is arranged between the two parallel branches and is designed as a switching unit, which is constructed in the same way as the switching unit used for the pre-charging circuit.

2. The interconnection device according to claim 1, wherein
the connecting elements are arranged to implement a parallel interconnection with at least two parallel branches of the input connections and comprise at least one bidirectional cross-connection switch, preferably a number of bidirectional cross-connection switches for each parallel branch corresponding to a number of pairs of input connections connected in series in the parallel branch, which are arranged between the two parallel branches, wherein the at least one bidirectional cross-connection switch is arranged between the two parallel branches.

3. The interconnection device according to claim 1, wherein
the connecting elements comprise at least one bypass switch (22), which is connected in parallel to the respective pair of input connections between this and one of the output connections in order to establish or disconnect a bypass of the respective pair of input connections depending on the switching state.

4. The interconnection device according to claim 1, wherein
the connecting elements comprise at least one controllable switch and the interconnection device comprises a control device which is configured to detect, during operation of the interconnection device, a current state of charge of a battery connected in parallel with the interconnection device with respect to an external electrical load (4) and to control the at least one controllable switch depending on the detected state of charge in order to provide a voltage adapted to the detected state of charge to the external contacts.

5. The interconnection device according to claim 1, wherein
the pre-charging circuit is designed as a switching unit with at least one semiconductor transistor switch.

6. The interconnection device according to claim 5, wherein
the pre-charging circuit has a dedicated inductance.

7. The interconnection device according to claim 5, wherein
the control device configured to gradually control the switch from permanently open to permanently and completely closed, depending on a current flowing during adjustment of the voltages to the pre-charging circuit.

8. The interconnection device according to claim 7, wherein
the pre-charging circuit has a switchable bypass of the switch that is bistable, which in the closed state has a lower electrical resistance than the switch in its closed state and which is configured to bypass the switch by closing the bypass after the switch has reached the permanently and completely closed state.

9. The interconnection device according to claim 5, wherein
the pre-charging circuit functionally forms an ideal diode.

10. (canceled)

11. A fuel cell device, comprising an interconnection device according to claim 1 and a plurality of fuel cell modules connected to the input connections thereof.

12. The fuel cell device according to claim 11, wherein
the fuel cell modules each have at least one decoupling switch designed as a bistable contactor, for galvanically isolating the respective fuel cell module from the remainder of the fuel cell device.

13. The fuel cell device according to claim 11, wherein
at least some of the fuel cell modules comprise different numbers of fuel cells.

14. The fuel cell device according to claim 13, wherein
the fuel cell modules can be interconnected by means of the interconnection device in several parallel branches, each of which comprises several fuel cell modules with different numbers of fuel cells interconnected in series, wherein the fuel cell modules in different parallel branches in the direction of the series interconnection are arranged in different order with regard to their numbers of fuel cells.

15. A motor vehicle comprising a fuel cell device according to claim 11 and a battery for supplying an electrical load of the motor vehicle, wherein the fuel cell device and the battery are connected in parallel to one another with respect to the electrical load without a DC-to-DC converter connected therebetween.

16. The interconnection device according to claim 3, wherein
the connecting elements comprise one bypass switch for each pair of input connections.

17. The fuel cell device according to claim 12, wherein
the fuel cell modules each have at least two decoupling switches internally.
